(19) United States
(12) Patent Application Publication
(10) Pub. No.: US 2008/0309051 A1
(43) Pub. Date: Dec. 18, 2008

(54) Accessory system

(75) Inventor: Matthew M. Elflein, Palm Harbor, FL (US)

Correspondence Address: TROUTMAN SANDERS LLP, 600 PEACHTREE STREET , NE, ATLANTA, GA, 30308, US

(73) Assignee: Wheeleazy, Inc., Glen Allen, VA (US)

(21) Appl. No.: 12/075,189

(22) Filed: Mar. 10, 2008

Related U.S. Application Data
(63) Continuation of application No. 11/811,763, filed on Jun. 12, 2007.

(51) Int. Cl. A61G 5/10

(52) U.S. Cl. 280/304.1

(57) ABSTRACT

A wheelchair has a frame with rails and wheels. An accessory is adapted to be removably coupled to a rail. The accessory has a short downwardly extending cylindrical projection. A coupling assembly extends between the accessory and the frame. The coupling assembly includes a bottom subassembly. The bottom subassembly is adapted to encompass a rail. The rail has a vertically extending lower component. The lower component has a cylindrical vertical recess. The coupling assembly also includes an extension subassembly. The extension subassembly is provided between the bottom subassembly and the accessory. A supplemental cylindrical recess is provided in the accessory above its projection. The recess is adapted to receive a supplemental component.

### RELATED APPLICATION

This application claims priority as a continuation-in-part application to U.S. patent application Ser. No. 11/811,763 filed on Jun. 12, 2007, which is hereby incorporated by reference.

### BACKGROUND

1. Field of the Invention

The present invention relates to a wheelchair/accessory system and more particularly pertains to extending the safety and utility of a wheelchair and for increasing the independence, comfort, and convenience to a user.

2. Description of the Prior Art

Wheelchairs assist many people with handicaps or injuries to have more independent mobility. However, wheelchairs in certain situations are cumbersome to use and sometimes require the assistance of others. In addition, though, accessories for wheelchairs are available, the accessories are typically difficult to install and remove for the person in chair and do not offer the flexibility that some people desire. Presently, wheelchair users have a limited number of products capable of extending the safety and utility of a wheel chair or providing comfort and convenience to the user. If a wheelchair user was in need of an accessory for their wheelchair, such as a table top or cup holder, the available solution was to wheel over to a free standing unit, such as a desk, have someone assist them with attaching the accessory, or place an accessory between their legs. These available options restrict the independent and mobility of the wheelchair user, provided only limited or no convenience to the user, and only marginally enhanced the life of the wheel chair user.

There has been an increased demand for wheelchair accessories to assist individuals confined to a wheelchair live an improved, more independent life. These accessories include a variety of products and devices, but all have inherent disadvantages. Currently, the devices and accessories available to the wheelchair user are those which rest on the lap of the user, attach to the arm rests of the wheel chair either permanently, with clamps or straps, or are stand alone devices which have limited portability.

By way of example, U.S. Pat. No. 5,813,948 issued Sep. 29, 1998 to Quigg relates to a Walker. U.S. Pat. No. 5,050,929 issued Sep. 24, 1991 to Gueringer relates to an Auxiliary Furniture Tray System. Lastly, U.S. Pat. No. 4,884,512 issued Dec. 5, 1989 to Kelly relates to a Platform Stabilizer.

Therefore, it can be appreciated that there exists a continuing need for a new and improved wheelchair/accessory system which can be used for extending the safety and utility of a wheelchair and for increasing the comfort and convenience to a user. In this regard, the present invention substantially fulfills this need.

### SUMMARY OF THE INVENTION

The inventor of the subject matter of the disclosure is a quadriplegic. The inventor developed the disclosed wheelchair accessory system and wheelchair accessory kits, and methods for using such system and kits to provide a system that may be easily used by the handicapped and injured to provide independence and convenience while in a wheelchair. This disclosure describes the flexibility on ease of use of various embodiments of the wheelchair accessory systems and kits.

In one embodiment, the accessory system comprises an accessory comprising a coupling portion and a supplemental accessory receiving portion and a coupling assembly comprising a connector and primary accessory receiving portion. The connector is capable of attaching the system to an object such as, but not limited to, a wheelchair, bed, or desk. The primary accessory receiving portion is capable of receiving the coupling portion of the accessory thereby attaching the accessory to the object for use. In this embodiment, the accessory comprises a supplemental accessory receiving portion capable of receiving the coupling portion of a second accessory. This allows stacking of accessories such as an umbrella holder on top of a desk accessory, for example, or an IV bag holder on top of an oxygen tank holder attached to a wheelchair for increased mobility of a patient or other person that would benefit from these treatments.

The accessory system may include any accessory that may be supported on the coupling assembly such as, but not limited to, a cup holder, a shelf with a cup holder, desk, a fishing rod holder, a camera support, an umbrella holder, a hook, a hook and closeable loop, an aperture and carabineer, an IV support pole, a shelf, an oxygen tank support, a magazine or book holder, or a food tray, for example. Any of such accessories may or may not include at least one additional accessory receiving portion to allow additional accessories to be added.

In embodiments of the accessory system may be integral to the object, such as, the coupling portion is integral to the frame of a wheelchair or otherwise permanently attached to a frame member of the wheelchair. In either case, wherein the coupling portion is removably attached, permanently attached, or integral to a wheelchair frame, in a preferred embodiment, the coupling portion does not increase the overall width of the wheelchair. For example, the coupling portion does not extend further from the wheelchair frame than the wheels of the wheelchair.

In another embodiment, a wheelchair accessory kit comprises at least two accessories, wherein each accessory comprises a coupling portion, and the accessory kit comprises an extension portion having an accessory receiving portion, wherein the coupling portions of each accessory are substantially similar and each coupling portion has of a complementary shape capable of mating with the accessory receiving portion. This embodiment allows one accessory to be removed from the extension and a second accessory to be connected to the extension using the same accessory receiving portion. Alternatively in such an embodiment, the accessories may comprise a coupling portion themselves; this embodiment allows the accessories to be switched from one accessory under the other to the opposite orientation, if desired.

In a further embodiment, a wheelchair accessory kit may comprise an attachment clamp comprising an accessory receiving portion and a wheelchair accessory comprising an integral extension, wherein the integral extension comprises an accessory coupling portion. This embodiment may be used to eliminate the need for a separate extension member, if desired.

It should be understood that the features may be described in separate embodiments, but one skilled in the art would understand that individual features of one embodiment may be combined with the features of another described embodiment to form a new combination as desired.

In further embodiments, the present invention may be a wheelchair/accessory system. First provided is a wheelchair. A typical wheelchair has a frame. In one configuration of a wheelchair, the frame may have laterally spaced horizontal seat rails, laterally spaced generally vertical back rails, and laterally spaced horizontal arm rails. The arm rails are provided forward of the back rails above the seat rails. The frame may also have laterally spaced horizontal, leg rails. The leg rails are provided forward of the back rails below the seat rails. In such a configuration, the frame may also have laterally spaced vertical front rails. The front rails are typically coupled to the arm rails and the seat rails and leg rails. A typical wheelchair has large rear wheels and smaller front wheels. The large wheels are positioned laterally outwardly of all the rails. An axis is provided. The axis is provided beneath the back rails and beneath the seat rails. The small wheels are positioned beneath the front rails.

An accessory is provided. In one embodiment, an accessory is adapted to be removably coupled to the wheelchair, such as, for example, at a location above one of the arm rails forward of one of the back rails, but may be located anywhere on the wheelchair. The accessory may be a shelf. The shelf may be a horizontal planar support surface, such as a planar surface in a rectangular, circular, oval, square, L-shaped or any other desired configuration. In certain embodiments of the shelf, the support surface may have an upwardly extending peripheral flange.

In another embodiment of the accessory, the accessory may comprise a circular aperture, such as a circular aperture through the support surface. The aperture may be used as a cup holder. The aperture may receive and removably support a cup or other object.

The accessory has a coupling portion. In one embodiment, the support surface may have a coupling portion having a downwardly extending cylindrical projection.

In certain embodiments, the accessory system also comprises a coupling assembly. The coupling assembly may extend between the accessory and the frame. The coupling assembly includes a bottom subassembly. The bottom assembly is connected, either integrally, permanently, or removably, to the frame of the object. For example, the coupling assembly may include an interior semi-circular section to encompass the frame. The bottom assembly may also comprise an exterior semi-circular section. The semi-circular sections are adapted to encompass one of a cylindrical rail. However, the bottom assembly may be designed to attach to frames of various objects, such as to encompass frames of any shape, such as square frames or screw directly into wood or metal.

In this respect, before explaining plural embodiments of the invention in detail, it is to be understood that the invention, is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side elevational view of a wheelchair with an accessory system constructed in accordance with the principles of the present invention;

FIG. 2 is an enlarged front elevational view taken along line 2-2 of FIG. 1;

FIG. 3 is an enlarged plan view taken along line 3-3 of FIG. 2;

FIG. 4 is a side elevational view of one component of an accessory system constructed in accordance with an alternate embodiment of the invention;

FIG. 5 is a front elevational view of components of an accessory system constructed in accordance with the second alternate embodiment of the invention;

FIG. 6 is an enlarged plan view taken along line 6-6 of FIG. 5;

FIG. 7 is a front elevational view of components of an accessory system constructed in accordance with the third alternate embodiment of the invention;

FIG. 8 is a front elevational view of components of a wheelchair accessory system constructed in accordance with the fourth alternate embodiment of the invention;

FIG. 9 is a front elevational view of components of an accessory system constructed in accordance with the fifth alternate embodiment of the invention;

FIG. 10 is an end elevational view taken along line 10-10 of FIG. 9;

FIG. 11 is a front elevational view of components of an accessory system constructed in accordance with the sixth alternate embodiment of the invention;

FIG. 12 is a side elevational view taken along line 12-12 of FIG. 11;

FIG. 13 is a side elevational view of an embodiment of the accessory system including, among other components, a shelf and an oxygen tank support;

FIG. 14 is a side elevational view of an embodiment of the accessory system including, among other components, a cup holder and an IV bag support;

FIG. 15 is a side view of a cup holder accessory on an extension member and FIG. 15a is a perspective view of an embodiment of a cup holder;

FIG. 16 is a side elevational view of an embodiment of the accessory system including, among other components, a clamp such as for an umbrella and a book or magazine rack; FIG. 16A is a top view of the clamp; and FIG. 16B is a top view of the book or magazine rack; and

FIG. 17 is a bottom perspective view of an embodiment of a table accessory.

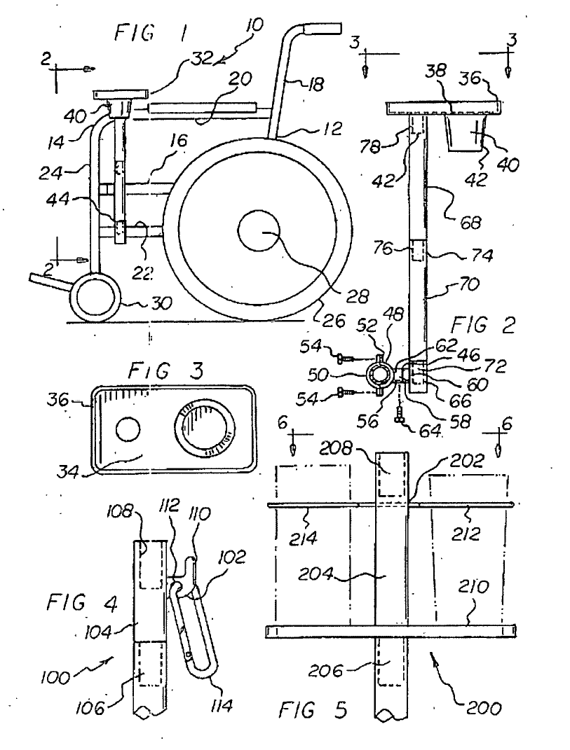

### DESCRIPTION OF EMBODIMENTS

The disclosure describes an accessory system for attachment to any object such as, but not limited to, a wheelchair, desk, or bed. The attachment systems and kits described herein provide flexibility to the users.

In one embodiment, the accessory system comprises an accessory and a coupling assembly. The coupling assembly may comprise a connector and primary accessory receiving portion. The connector of the coupling assembly is capable of attaching to the object. The accessory receiving portion receives a coupling portion of the accessory. In certain embodiments, the accessory may comprise a supplemental accessory receiving portion for receiving a second accessory or an extension member. The coupling assembly may be integral to, permanently attached, or removable attached to the object.

The accessory of the accessory system or kit may be any desired accessory, such as, but not limited to a cup holder, a shelf with a cup holder, a fishing rod holder, an umbrella holder, a hook, a hook and closeable loop, an aperture and carabineer, a desk, and IV support pole, a shelf, an oxygen tank support, a magazine or book holder, a shelf, an ashtray, or a food tray.

In embodiments of the accessory system or kit, the coupling portion is capable of mating with the accessory receiving portion. The coupling portion and the accessory receiving portion may be any complementary shapes. As used herein, complementary shapes means two shapes that may be connected together. For example, one portion may have a male shape and the other has a female shape. The male shape fits in the female shape in such a manner that the two portions securely mate. For example, the primary accessory receiving portion is complementary shape of the coupling portion such the primary accessory portion and coupling portion mate to hold the accessory to the coupling assembly. Therefore, either the coupling portion or the accessory receiving portion may be, for example, but not limited to, cylindrical projection, keyed projection, a threaded connection, a quick lock connection, a cylindrical recess, or a recess.

The coupling assembly in some embodiments may comprise a bottom subassembly. The bottom subassembly may comprise the connector that is adapted to be attached to a rail. The coupling assembly may additionally comprise an extension. In such an embodiment, the extension may comprise a primary accessory receiving portion and the bottom subassembly comprises the connector. The extension may comprise a bottom extension portion that comprises a tertiary accessory receiving portion and a top extension portion that comprises the primary accessory receiving portion. In a preferred embodiment, the primary accessory receiving portion and the secondary accessory receiving portion have substantially the same shape. In a more preferred embodiment, the primary accessory receiving portion, the secondary accessory receiving portion, and the tertiary receiving portion have substantially the same shape. In such an embodiment, the accessories and the extensions may be combined in any order and multiple accessories may be combined.

Embodiments of the wheelchair accessory kit may comprise an attachment clamp, at least one extension member, and an accessory capable of attaching to the extension member. For more flexibility in attaching the accessory, the accessory kit may comprise two or more connectable extension members. Each extension member may be of a different length to further expand the flexibility in which the kit may be attached to the object. In certain applications, it may be desirable and it is possible to connect the accessory between two extension members. Further, the accessory may comprise an integral extension, wherein the integral extension comprises an accessory coupling portion.

Embodiments of the accessory kit may comprise more than one accessory. In preferred embodiments of the accessory kit, each accessory comprises a coupling portion, wherein the extension portion comprising an accessory receiving portion, wherein the coupling portions of each accessory are substantially similar and each coupling portion have of a complementary shape capable of mating with the accessory receiving portion.

With reference now to the drawings, and in particular to FIG. 1 thereof, an embodiment wheelchair/accessory system embodying the principles and concepts of the present invention and generally designated by the reference numeral 10 will be described.

The present invention, the wheelchair/accessory system 10 is comprised of a plurality of components. Such components in their broadest context include an accessory and a coupling assembly. The accessory may also include a supplemental coupling portion. Such components are individually configured and correlated with respect to each other so as to attain the desired objective.

First described is a wheelchair 12. The accessory system or kit may be attached to wheelchair 12, for example. The wheelchair has a frame 14. The frame has laterally spaced horizontal seat rails 16. The frame has laterally spaced generally vertical back rails 18. The frame also has laterally spaced horizontal arm rails 20. The arm rails are provided forward of the back rails above the seat rails. The frame also has laterally spaced horizontal leg rails 22. The leg rails are provided forward of the back rails below the seat rails. The frame also has laterally spaced vertical front rails 24. The front rails are coupled to the arm rails and the seat rails and leg rails. The wheelchair has large wheels 26. The large wheels are positioned laterally outwardly of all the rails. An axis 28 is provided. The axis is provided beneath the back rails and beneath the seat rails. The wheelchair has small wheels 30. The small wheels are positioned beneath the front rails.

One skilled in the art would recognize that the basic configuration of a wheelchair is as varied as the manufacturer. A wheelchair is designed to carry a person's weight. The frame, in any one of the many varied configurations, achieves this purpose. Frame members may be perpendicular to one another or may be angled to one another, depending on configuration of the wheelchair.

An accessory 32 is provided. The accessory may be adapted to be removably coupled to the wheelchair at a location above one of the arm rails forward of one of the back rails or elsewhere on the wheelchair as desired. The embodiment of the accessory 32 has a horizontal planar support surface 34. The support surface 34 is in a rectangular configuration. In the preferred embodiment, the support surface 34 has an upwardly extending peripheral flange 36, though in other embodiments the flange may not be present. In that configuration the support surface may be a planar surface.

A circular aperture 38 may be provided through the support surface. The aperture may receive and removably support a cup 40, for example. The cup 40 has a generally conical surface. The support surface 34 of this embodiment has a short downwardly extending cylindrical projection 42 as a coupling portion. The projection is laterally spaced from the aperture.

Provided next is an embodiment of a coupling assembly 44. The coupling assembly 44 extends between the accessory and the frame. The coupling assembly includes a bottom subassembly 46. The embodiment of the bottom assembly shown in FIG. 1 has an interior semi-circular section 48. The bottom section has an exterior semi-circular section 50. The semi-circular sections are adapted to encompass one of the leg rails. One skilled in the art would recognize, however, that any part of the wheelchair frame may serve as a mounting point for the coupling assembly and various methods and connection types may be used, such as permanent or removable or the coupling assembly or portions of the coupling assembly may be made integral to an object for mounting the accessory.

In the embodiment of FIG. 1, the semi-circular sections have vertical projections 52. The semi-circular sections have threaded coupling apertures and coupling bolts 54. The coupling bolts extend through the coupling apertures for coupling purposes. The interior semicircular section has a horizontally projecting female member 56. The female member has a cylindrical recess. The recess is formed with a threaded rotational positioning aperture 58. The bottom subassembly may have a vertically extending lower component 60. The lower component may have a horizontally projecting male member 62. A cylindrical projection may be positioned in the cylindrical recess. In this embodiment, a rotational positioning bolt 64 is provided in the rotational positioning aperture. In this manner, rotational positioning and rotational locking is provided. The vertically extending lower component has a cylindrical vertical recess 66.

The coupling assembly also has an extension subassembly. The extension subassembly includes a vertical upper component 68. The extension subassembly includes a similarly configured vertical intermediate component 70. The intermediate component has a lower end. The lower end has a downwardly extending cylindrical projection 72. The projection is positioned within the vertical recess of the bottom component. The intermediate component has an upper end. The upper end has a vertically extending cylindrical recess 74. The upper component has a lower end. The lower end has a downwardly extending cylindrical projection 76 projection is positioned within the vertical recess of the intermediate component. The upper component has an upper end. The upper end has a vertically extending cylindrical recess 78. The recess receives the projection of the accessory.

Provided in an embodiment is a supplemental cylindrical recess 80. The recess may be provided in the planar surface of the accessory above its projection. The recess is adapted to receive a supplemental component.

From a generic standpoint, the invention includes a wheelchair which has a frame with rails and wheels. An accessory is adapted to be removably coupled to a rail. The accessory has a short downwardly extending cylindrical projection. A coupling assembly extends between the accessory and the frame. The coupling assembly includes a bottom subassembly. The bottom subassembly is adapted to encompass a rail. The rail has a vertically extending lower component. The lower component has a cylindrical vertical recess. The coupling assembly also includes an extension subassembly. The extension subassembly is provided between the bottom subassembly and the accessory. A supplemental cylindrical recess is provided in the accessory above its projection. The recess is adapted to receive a supplemental component.

An alternate embodiment of the present invention is system 100 shown in FIG. 4. An accessory 102 is provided. The accessory is a hook and closeable loop. This accessory allows a person confined to a wheelchair to carry articles in plastic shopping bags. The hook allows the bags to be hooked and carried. The closeable loop may also be used to secure the looped handles of the plastic shopping bags. In this way the person can carry goods from the store without fear of dropping and damaging the goods. The accessory further includes a vertically extending rod 104. The vertically extending rod has a downwardly extending projection 106. The projection is provided at the lower end of the rod. The projection is positionable in the supplemental cylindrical recess of the accessory. An upwardly facing recess 108 is provided. The upwardly facing recess is provided at the upper end of the rod. The rod is formed with an L-shaped finger 110. An aperture 112 is provided through the finger adjacent to a central extent of the finger. A carabineer ring 114 is provided. The carabineer ring is positioned within the aperture. The carabineer ring is configured to secure articles such as a laundry basket and plastic shopping bags. The upward facing recess 108 allows for the stacking of accessories. In the case of the L-shaped finger and carabineer ring accessory, the recess 108 allows the user to place another accessory, such as an umbrella, into the recess. In this way the person may push his or her wheelchair in the rain, without concern for dropping the articles held by the carabineer ring or hook.

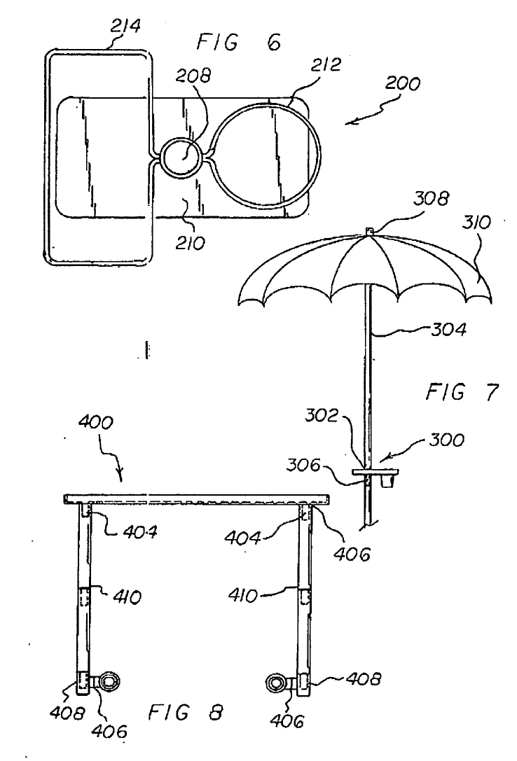

A second alternate embodiment of the present invention, system 200, is shown in FIGS. 5 and 6. An accessory 202 is provided. The accessory further includes a vertically extending rod 204. The vertically extending rod has a downwardly extending projection 206. The projection is provided at the lower end of the rod. The projection is positionable in the supplemental cylindrical recess of the accessory. An upwardly facing recess 208 is provided. The upwardly facing recess is provided at the upper end of the rod. The rod is formed with a horizontally disposed rectangular support surface 210. The support surface is provided adjacent to the lower end. Wire supports 212, 214 are provided. The wire supports are provided adjacent to the upper end. The wire supports are adapted to provide stability to objects on the support surface.

This accessory is configured, in one embodiment, to accommodate a large soft drink and a bag, or container of popcorn. The wire supports may be somewhat malleable, so as allow a user to conform the wire support to the container the person desires the support to contain.

Shown in FIG. 7 is a third alternate embodiment of the present invention, system 300. An accessory 302 is provided. The accessory further includes a vertically extending rod 304. The vertically extending rod has a downwardly extending projection 308. The projection is provided at the lower end of the rod. The projection is positionable in the supplemental cylindrical recess of the accessory. The vertically extending rod has an upper end 308. The rod is formed as an umbrella shaft. The lower end constitutes a handle. The upper end is formed as a rain shield 310.

The system 400 of the fourth alternate embodiment of the present invention is provided. Note FIG. 8. An accessory 402 is provided. The accessory is removably coupled to laterally disposed rails. The accessory has laterally disposed short downwardly extending cylindrical projections 404. The coupling assembly extends between the accessory and the frame. The coupling assembly includes bottom subassemblies 406. The bottom subassemblies are adapted to encompass laterally disposed rails. The bottom subassemblies have vertically extending lower components 408. The lower components have cylindrical vertical recesses. The coupling assembly also has laterally disposed extension subassemblies 410. The laterally disposed extension subassemblies are provided between the bottom subassemblies and the accessory.

In general, FIG. 8 demonstrates the use of two devices on a single wheelchair. This allows firm mounting for a planar surface, such as a writing desk top, to be affixed to the wheelchair. In this embodiment the desktop accessory has two mounting points so as to receive the two extension subassemblies. The advantage of two mounting points is strength, stability, and increased weight capacity over one mounting point.

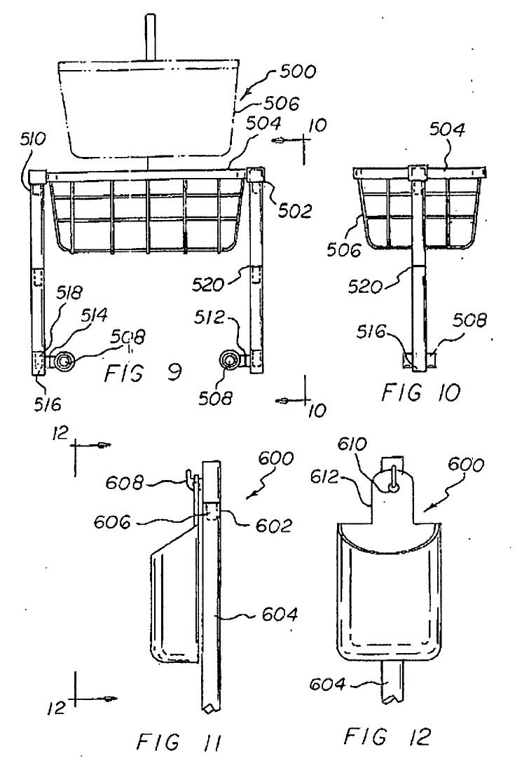

The fifth alternate embodiment of the invention is a system 500 illustrated in FIGS. 9 and 10. In such system, the accessory 502 is a peripheral frame 504 adapted to removably receive a basket 506. The accessory is removably coupled to laterally disposed rails 508. The accessory in this embodiment has laterally disposed short downwardly extending cylindrical projections 510. The embodiment comprises coupling assembly 512 that extends between the accessory and the frame and includes bottom subassemblies 514 adapted to encompass laterally disposed rails. The vertically extending lower components 516 have cylindrical vertical recesses 518. The coupling assembly also has laterally disposed extension subassemblies 520 between the bottom subassemblies and the accessory.

The sixth alternate embodiment of the invention is a system 600 illustrated in FIGS. 11 and 12. In such embodiment, the accessory 602 further includes a vertically extending rod 604 with a downwardly extending projection at its lower end and an upwardly facing recess 606 at its upper end. The rod is formed with an L-shaped finger 68. The finger is adapted to receive and support an aperture 610 in a bag 612.

An embodiment of the accessory system 700 is shown in FIG. 13. The accessory system 700 of FIG. 13 comprises a coupling assembly 710 with connector 710a and an accessory receiving portion 710b. The connector 710a is capable of being attached to an object, such as, but not limited to, a wheelchair. An extension 712 comprises a coupling portion 712a which is mated to the accessory receiving portion 710b. As shown in FIG. 13, the accessory receiving portion 710b is a male connector and the coupling portion 712a is a complementary female connector. This is merely an example and the accessory receiving portion 710b may be a female connector and the coupling portion 712a may be a complementary male connector, for example.

In the same manner, the oxygen support accessory 714 is connected to extension 712 by the mating of the accessory receiving portion 712b, a female connector, and the coupling portion 714a, a complementary male connector. An oxygen supply tank may be supported on the oxygen support accessory 714, which may optionally comprise attachment members 714c such as straps or brackets. A second extension 715 may be used in a similar manner to elevate a second accessory such as shelf 716 above the first accessory.

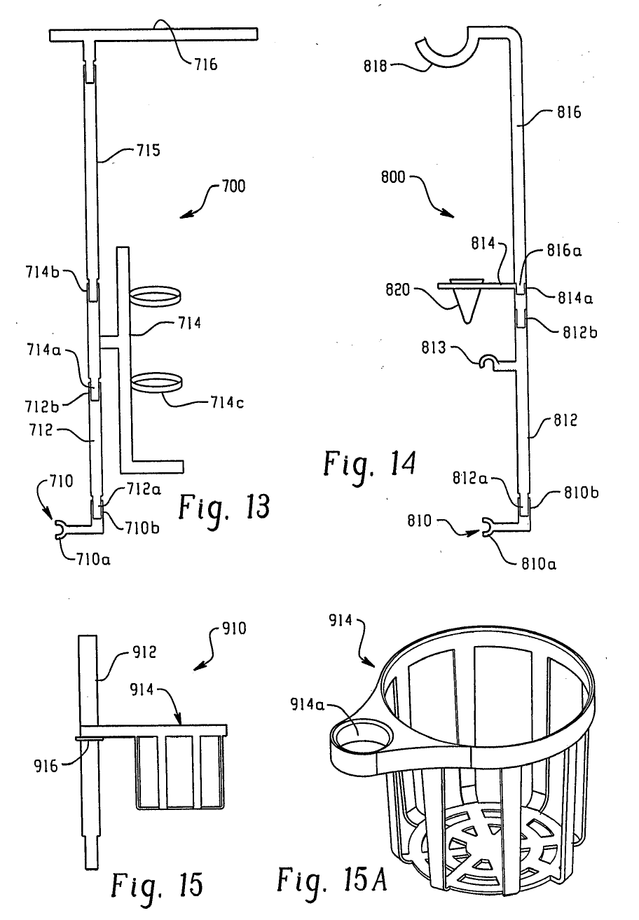

A further embodiment of the accessory system 800 is shown in FIG. 14. The accessory system 800 of FIG. 14 comprises a coupling assembly 810 with connector 810a and an accessory receiving portion 810b. As in other embodiments, the connector 810a is capable of being attached to an object, such as, but not limited to, a wheelchair. An extension 812 comprises a coupling portion 812a which is mated to the accessory receiving portion 810b. As shown in FIG. 14, the accessory receiving portion 710b is a male connector and the coupling portion 712a is a complementary female connector. The extension 812 comprises a second connector 813 which is capable of providing a second connection to the object, thereby providing greater support for the accessories. The connector 813 is capable of receiving a rail of a wheelchair, for example, but any connector including integral connectors, permanent connectors, or removable connectors may be used.

Connected to extension 812 is a shelf with a cup holder 814. A cup 820 is shown in the shelf with the cup holder 814. The shelf with a cup holder 814 comprises a supplemental accessory receiving portion 814a. In the same manner, the IV support stand 816 accessory is connected to the shelf with cup holder 814 accessory in the supplemental accessory receiving portion 814a by the mating coupling portion 816a of the IV support stand 816 accessory. The IV support stand 816 comprises a hook 818 that may be used to suspend an IV solution bag.

A further embodiment of a cup holder accessory 910 is shown in FIG. 15. The cup holder accessory 910 comprises a cup holder 914 that is supported on an extension 912 by a ring 916 such as an o-ring or clamp that may be tightened onto an extension 912 to support the accessory. Other accessories such as hooks or brackets may be supported on an extension or other accessory in a similar manner. FIG. 15A is a perspective view of the embodiment of the cup holder 914 of FIG. 15. The cup holder 914 has a coupling portion 914a that is used in conjunction with ring 916 to attach the cup holder to the extension 912.

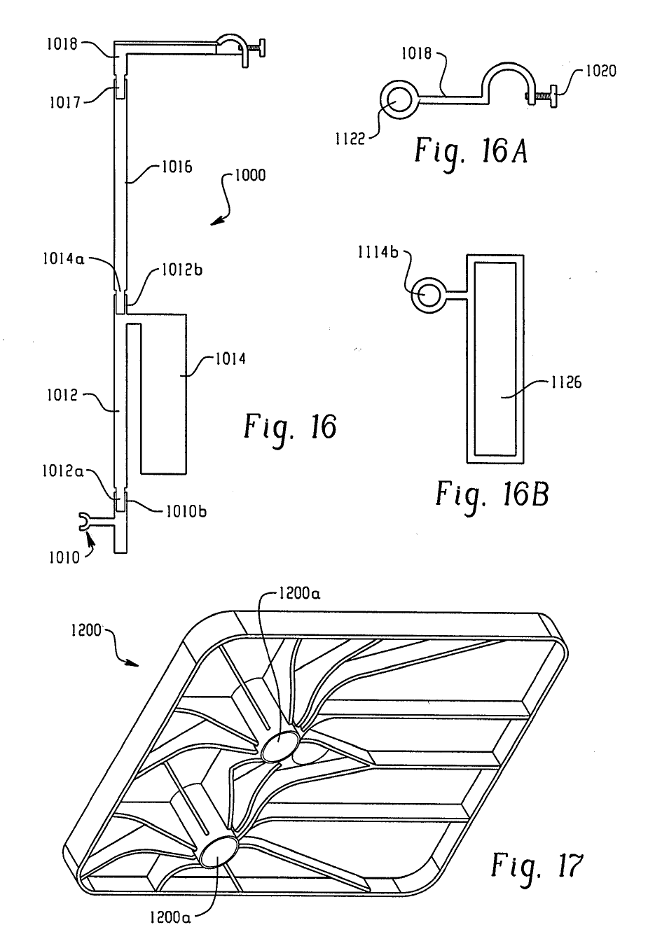

An additional embodiment of the accessory system 1000 is shown in FIGS. 16, 16A, and 16B. The accessory system 1000 of FIG. 15 similarly comprises a coupling assembly 1010. An extension 1012 comprises a coupling portion 1012a which is mated to the accessory receiving portion 710b. As shown in FIG. 15, in a similar manner, a magazine or book rack 1014 accessory is connected to extension 1012 by the mating of the accessory receiving portion 1012b and the coupling portion 1014a, with complementary connector portions. A top view of the magazine or book shelf 1014 is shown in FIG. 16B. The magazine or book rack 1014 accessory comprises an accessory receiving portion 1014b and a recess 1126 for storing magazine, books, or any other object that will fit in recess 1126. A second extension 1016 supports a second accessory. In the embodiment shown in FIG. 16, the second accessory is a clamp 1018. The clamp 1018 may be used to attach an umbrella, flag, or any other object capable of being held by clamp 1018. FIG. 16B shows a top view of clamp 1018. Clamp 1018 comprises a supplemental accessory receiving portion 1022 and a set screw 1020 for securing the object.

An accessory may include multiple coupling portions to allow adjustment of the relative location of the accessory relative to the accessory receiving portion. FIG. 17 shows an embodiment of a shelf 1200 that comprises to coupling portions 1200a. Either or both of the coupling portions may be used to support the shelf 1200.

As to the manner of usage and operation of the present invention, the same should be apparent from the above description. Accordingly, no further discussion relating to the manner of usage and operation will, be provided.

With respect to the above description, it is to be realized that the optimum dimensional relationships for the parts of the invention, to include variations in size, materials, shape, form, function and manner of operation, assembly and use, are readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1.-10. (canceled)

11. An accessory system, comprising:
an accessory comprising a coupling portion and a supplemental accessory receiving portion;
a coupling assembly comprising a connector and primary accessory receiving portion.

12. The accessory system of claim 11, wherein the accessory is selected from a cup holder, a shelf with a cup holder, a fishing rod holder, an umbrella holder, a hook, a hook and closeable loop, an aperture and carabineer, a desk, and IV support pole, a shelf, an oxygen tank support, a magazine or book holder, a shelf, or a food tray.

13. The accessory system of claim 11, wherein the coupling portion is one of a cylindrical projection, keyed projection, a threaded connection, a quick lock connection, a cylindrical recess, or a recess.

14. The accessory system of claim 11, wherein the coupling assembly comprises a bottom subassembly and the bottom assembly comprises the connector that is adapted to be attached to a rail.

15. The accessory system of claim 14, wherein the coupling assembly comprises an extension.

16. The accessory system of claim 15, wherein the extension comprises the primary accessory receiving portion and the bottom subassembly comprises the connector.

17. The accessory system of claim 16, wherein the extension comprises a bottom extension portion that comprises a tertiary accessory receiving portion and a top extension portion that comprises the primary accessory receiving portion.

18. The accessory system of claim 11, wherein the primary accessory receiving portion and the secondary accessory receiving portion have substantially the same shape.

19. The accessory system of claim 11, wherein the connector is capable of connecting the accessory system to a wheelchair, desk, or a bed.

20. The accessory system of claim 18, wherein the primary accessory receiving portion is complementary shape of the coupling portion such the primary accessory portion and coupling portion mate to hold the accessory to the coupling assembly.

21. The accessory system of claim 17, wherein the primary accessory receiving portion, the secondary accessory receiving portion, and the tertiary receiving portion have substantially the same shape.

22. A wheelchair, comprising:
an accessory support portion permanently attached to a frame member of the wheelchair.

23. A wheelchair accessory kit, comprising:
at least two accessories, wherein each accessory comprises a coupling portion; and
an extension portion comprising an accessory receiving portion, wherein the coupling portions of each accessory are substantially similar and each coupling portion have of a complementary shape capable of mating with the accessory receiving portion.

24. The wheelchair accessory kit of claim 23, wherein the accessories are selected from a cup holder, a shelf with a cup holder, a fishing rod holder, an umbrella holder, a hook, a hook and closeable loop, an aperture and carabineer, a desk, and IV support pole, a shelf, an oxygen tank support, a magazine or book holder, a shelf, or a food tray.

25. The wheelchair accessory kit of claim 24, wherein the extension portion comprises at least two sections, wherein each section has an accessory receiving portion and a coupling portion.

26. The wheelchair accessory kit of claim 25, wherein at least one of the accessories comprises an accessory receiving portion.

27. The wheelchair accessory kit of claim 25, wherein at least one extension portion comprises a support member.

28. A wheelchair accessory kit, comprising:
an attachment clamp;
at least one extension member; and
an accessory capable of attaching to the extension member.

29. The wheelchair accessory kit of claim 28, comprising at least two connectable extension members.

30. The wheelchair accessory kit of claim 29, wherein the accessory is capable of being attached between two extension members.

31. The wheelchair accessory kit of claim 28, wherein the accessory is selected from a cup holder, a shelf with a cup holder, a fishing rod holder, an umbrella holder, a hook, a hook and closeable loop, an aperture and carabineer, a desk, and IV support pole, a shelf, an oxygen tank support, a magazine or book holder, a shelf, or a food tray.

32. The accessory kit of claim 29, comprising at least two extensions.

33. A wheelchair accessory kit, comprising:
an attachment clamp comprising an accessory receiving portion; and
a wheelchair accessory comprising an integral extension, wherein the integral extension comprises an accessory coupling portion.

34. The wheelchair accessory kit of claim 33, wherein the attachment clamp is capable of being clamped to a rail.

35. The wheelchair accessory kit of claim 34, wherein the rail is a leg rail of a wheelchair forward of the front wheel.

36. The wheelchair accessory kit of claim 35, wherein the integral extension is capable of supporting the accessory above an arm rail of the wheelchair.

37. The wheelchair accessory kit of claim 33, wherein the rail is on a wheelchair, bed, hospital bed, or desk.
